(19) United States
(12) Patent Application Publication
(10) Pub. No.: US 2005/0195272 A1
(43) Pub. Date: Sep. 8, 2005

(54) Optical scanning apparatus for use in image forming apparatus having plural photosensitive members and semiconductor laser chip for use therein

(75) Inventor: Junya Azami, Mishima-shi (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 11/061,450

(22) Filed: Feb. 22, 2005

(30) Foreign Application Priority Data
Feb. 24, 2004 (JP) 2004-047397

(51) Int. Cl. B41J 2/45

(52) U.S. Cl. 347/238

(57) ABSTRACT

An optical scanning apparatus for mounting in an image forming apparatus having plural photosensitive members, includes: a semiconductor laser chip having plural light emission points; and deflection device which deflects plural laser beams emitted from the semiconductor laser chip; wherein the semiconductor laser chip is a vertical cavity surface emitting laser for emitting a laser beam in a direction perpendicular to a substrate plane of the chip, and, a first laser beam group constituted at least of two laser beams, among plural laser beams deflected by the deflection device, enters a first photosensitive member while a second laser beam group constituted at least of two laser beams other than the first laser beam group, among plural laser beams deflected by the deflection device, enters a second photosensitive member; and
wherein a distance d2 between a first light emission point group emitting the first laser beam group on the semiconductor laser chip and a second light emission point group emitting the second laser beam group on the semiconductor laser chip is larger than a distance d1 of light emission points of the first light emission point group.

### BACKGROUND OF THE INVENTION

1. Field of the Invention

The present invention relates to an optical scanning apparatus to be employed on a copying machine or a printer of an electrophotographic process and a semiconductor chip to be mounted on such optical scanning apparatus, and more particularly to an optical scanning apparatus to be employed in a copying machine or a printer having plural photosensitive members, and a semiconductor chip to be mounted on such apparatus.

2. Related Background Art

In recent copying machine and printer, a simplification in the structure is requested for the purpose of cost reduction. An optical scanning apparatus with a simplified configuration of the optical system, for use in a color image forming apparatus of an electrophotographic process, is proposed for example in Japanese Patent Application Laid-open No. 2001-4948. In this apparatus, as shown in FIG. 12, plural laser beams are deflected by a polygon mirror 320 to scan respectively different photosensitive drums 20A, 20B, 20C and 20D thereby forming respectively different color images thereon, which are superposed on an unillustrated recording sheet to obtain a color image. Thus, it is so constructed that all the plural laser beams for respectively scanning the plural photosensitive drums are deflected by a single polygon mirror 320 and are passed by fθ lenses 400 and 500.

Also a laser light source apparatus (light source unit) 100 to be mounted on the aforementioned optical scanning apparatus is shown in FIGS. 13A and 13B, in which FIG. 13B is a view seen in a direction B shown in FIG. 13A. As shown in FIGS. 13A and 13B, there are provided laser light source (semiconductor lasers) 120A, 120B, 120C and 120D, and laser beams emitted therefrom are respectively converted into parallel light beams by collimating lenses 120A1, 120B1, 120C1 and 120D1, then arranged on a line by synthesizing prisms 150A, 150B, and enter the polygon mirror 320 for deflection. The semiconductor lasers 120A, 120B, 120C and 120D are respectively mounted with semiconductor laser chips 120a, 120b, 120c and 120d. Therefore, the image forming apparatus is equipped with four semiconductor lasers for scanning the photosensitive member.

Also Japanese Patent Application Laid-open No. 2000-330049 describes, as shown in FIG. 14, an image forming apparatus utilizing a multi-beam laser light source 111 for emitting, from a single element (semiconductor laser chip), plural laser beams which are deflected by a polygon mirror 115, separated by a separating element 118 into plural laser beams and reflected by a fold-back mirror 117 to scan photosensitive drums 119A, 119B, 119C and 119D.

However, the aforementioned prior configurations are associated with certain problems to be solved. Firstly, the structure shown in Japanese Patent Application Laid-open No. 2001-4948 has a large number of components constituting the laser light source apparatus and has drawbacks of a high production cost because of difficulty in assembly and adjustment, and a tendency to cause an aberration in the irradiating direction of the laser for example by a temperature change, facilitated by a large number of components.

Also the structure shown in Japanese Patent Application Laid-open No. 2003-330049 is difficult to achieve a high speed by utilizing multiple beams. In order to increase the recording speed of a color image forming apparatus, it is common to rotate the polygon mirror 115 at a high speed, but such method has a limitation because of an increase in the vibration and the noises. Therefore, a multiple-beam structure is often employed recently. For example, a scanning of a photosensitive drum with two beams allows to obtain a doubled recording speed even at a same revolution of the polygon mirror 115.

However, in the apparatus described in Japanese Patent Application Laid-open No. 2003-330049, in order to scan each photosensitive drum with two or more laser beams, 8 or more light-emitting points are required in the semiconductor laser chip. In such case, in an ordinarily employed laser of end face emission type, a heat generation becomes excessively large to increase a thermal crosstalk, leading to a deterioration in the image quality.

It is therefore conceivable also to utilizing a vertical cavity surface emitting laser as described in Japanese Patent Application Laid-open No. H10-301044.

However, with an increase in the number of the light-emitting points in a single semiconductor laser chip, it becomes difficult to separate the laser beams for directing toward the respective photosensitive drums, and a designing of such system is difficult.

### SUMMARY OF THE INVENTION

The present invention has been made in consideration of the aforementioned situations and an object of the present invention is to provide an optical scanning apparatus of a simple structure.

Another object of the present invention is to provide an optical scanning apparatus in which a laser beam directed toward each photosensitive member is not easily intercepted by a mirror on the way, and a semiconductor laser chip to be mounted on such apparatus.

Still another object of the present invention is to provide an optical scanning apparatus of a low cost, enabling easy designing while suppressing a deterioration in the image quality by a thermal crosstalk, and a semiconductor laser chip to be mounted on such apparatus.

Still another object of thee present invention is to provide an optical scanning apparatus including:
a semiconductor laser chip having plural light emission points; and
deflection means which deflects plural laser beams emitted from the semiconductor laser chip;
wherein the semiconductor laser chip is a vertical cavity surface emitting laser for emitting a laser beam in a direction perpendicular to a substrate plane of the chip, and, a first laser beam group constituted at least of two laser beams, among plural laser beams deflected by the deflection means, enters a first photosensitive member while a second laser beam group constituted at least of two laser beams other than the first laser beam group, among plural laser beams deflected by the deflection means, enters a second photosensitive member; and
wherein a distance d2 between a first light emission point group emitting the first laser beam group and a second light emission point group emitting the second laser beam group is larger than a distance d1 of light emission points of the first light emission point group.

Still another object of the present invention is to provide a semiconductor laser chip including:
a substrate; and
plural light emission points formed on the substrate for emitting laser beams in a direction perpendicular to a plane of the substrate;
wherein a distance d2 between a first light emission point group emitting a first laser beam group constituted at least of two laser beams, among plural laser beams emitted from the plural light emission points, and a second light emission point group emitting a second laser beam group constituted at least of two laser beams other than the first laser beam group, is larger than a distance d1 of light emission points of the first light emission point group.

Still other objects of the present invention will become fully apparent from the following detailed description which is to be taken in conjunction with the accompanying drawings.

### BRIEF DESCRIPTION OF THE DRAWINGS

FIG. 1 is a cross-sectional view of an optical scanning apparatus of the present invention;

FIG. 2 is a cross-sectional view of an optical scanning apparatus of the present invention;

FIG. 3 is a cross-sectional view of a color image forming apparatus utilizing an optical scanning apparatus of the present invention;

FIG. 4 is a schematic view of a VCSEL;

FIG. 5 is a schematic view of a semiconductor laser chip of a first embodiment;

FIG. 6 is a schematic view of a semiconductor laser chip of a first embodiment in which each light emission point group has three light emission points;

FIG. 7 is a schematic view of a semiconductor laser chip of a second embodiment;

FIG. 8 is a view showing a gap regulation of scanning lines utilizing the semiconductor laser chip of the first embodiment;

FIGS. 9, 10A and 10B are views showing a gap regulation of scanning lines utilizing the semiconductor laser chip of the second embodiment;

FIG. 11 is a schematic view of a semiconductor laser chip of a second embodiment in which each light emission point group has three light emission points;

FIG. 12 is a cross-sectional view of a prior optical scanning apparatus;

FIGS. 13A and 13B are an elevation view and a lateral view of a light source unit mounted in the optical scanning apparatus shown in FIG. 12; and

FIG. 14 is a cross-sectional view of a prior optical scanning apparatus.

### DETAILED DESCRIPTION OF THE PREFERRED EMBODIMENTS

### First Embodiment

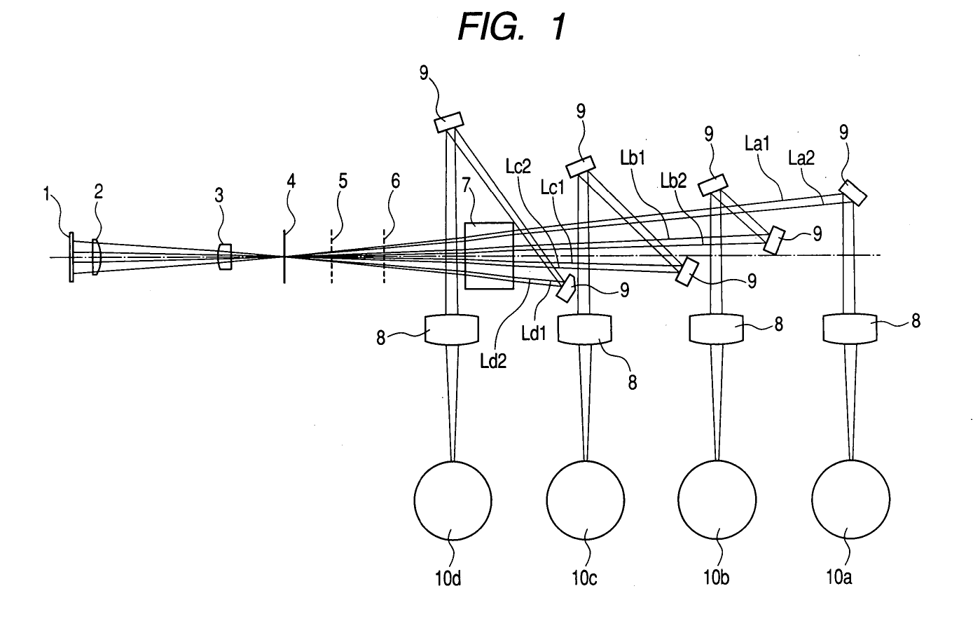

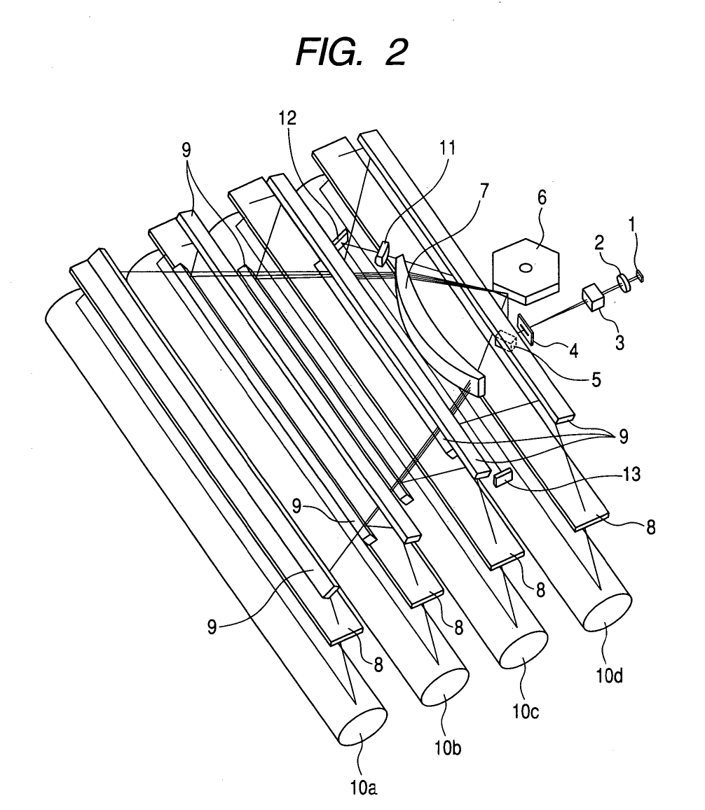

FIGS. 1 and 2 are respectively a cross-sectional view along a sub scanning direction and a perspective view of an optical scanning apparatus constituting a first embodiment of the present invention.

(Entire Structure of Optical Scanning Apparatus)

Referring to FIGS. 1 and 2, there are shown a multi-beam laser light source (semiconductor laser chip) 1 having plural light emission points for emitting plural laser lights (laser beams), a collimating lens 2, a cylindrical lens 3, an optical diaphragm 4, an entrance mirror 5, a polygon mirror 6, a first scanning lens 7, a second scanning lens 8, a fold-back mirrors 9, photosensitive drums 10a, 10b, 10c and 10d, a lens 11 provided in a synchronizing detection optical path, a mirror 12 provided in a synchronizing detection optical path, and a synchronizing sensor 13.

In the present embodiment, the multi-beam laser light source 1 emits 8 laser beams La1, La2, Lb1, Lb2, Lc1, Lc2, Ld1 and Ld2, which are converted into parallel light beams by the collimating lens 2, then into light beams converging only in a sub scanning direction by the cylindrical lens 3, then restricted in a part of the light beams by the optical diaphragm 4, deflected by the entrance mirror 5 and focused as line images on the polygon mirror (deflection means) 6. Then, these laser beams are deflected by the polygon mirror 6, guided through the first scanning lens 7, the fold-back mirrors 9 and the second scanning lens 8 to scan the respective photosensitive drums 10a, 10b, 10c, 10d.

The 8 laser beams emitted from the light emission points of the multi-beam laser light source 1, after passing the first scanning lens 7, are separated by the fold-back mirrors 9 (provided in 7 units in the present embodiment) into groups of two beams each, which respectively scan different photosensitive drums. More specifically, the laser beams La1 and La2 (first laser beam group) scan the photosensitive drum 10a, the laser beams Lb1 and Lb2 (second laser beam group) scan the photosensitive drum 10b, the laser beams Lc1 and Lc2 (third laser beam group) scan the photosensitive drum 10c, and the laser beams Ld1 and Ld2 (fourth laser beam group) scan the photosensitive drum 10d.

Thus, each of the photosensitive drums 10a, 10b, 10c, 10d is scanned simultaneously with two laser beams, thereby attaining a recording speed which is twice of the case of scanning with a single laser beam.

Also a part of the laser beams deflected by the polygon mirror 6 is focused and scans a synchronization sensor 13 through the lens 11 and the mirror 12, thus used for generating a horizontal synchronization signal.

(Entire Structure of Image Forming Apparatus)

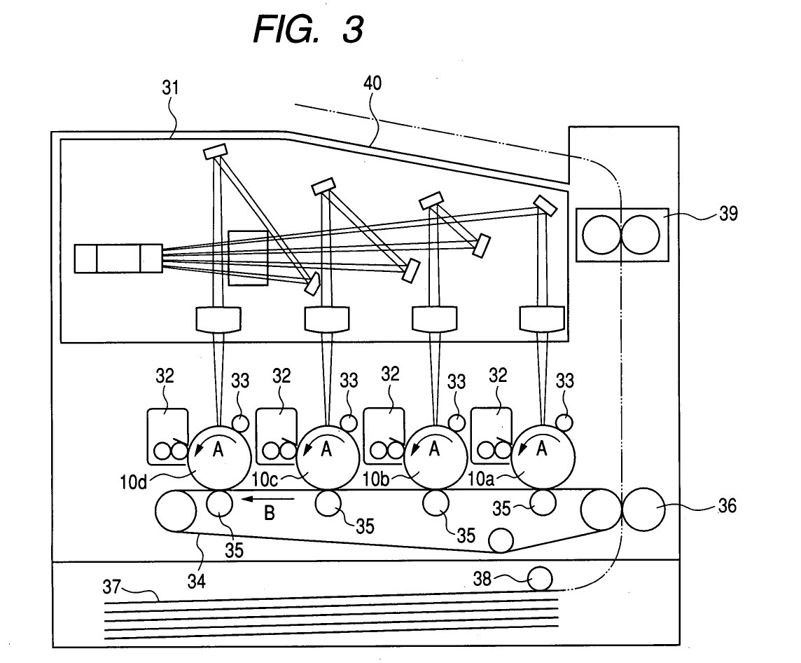

FIG. 3 is a schematic cross-sectional view of a color image forming apparatus utilizing the optical scanning apparatus. Referring to FIG. 3, there are shown an optical scanning apparatus 31 shown in FIGS. 1 and 2, developing devices 32, charging rollers 33, an intermediate transfer belt 34, primary transfer rollers 35, a secondary transfer roller 36, a recording sheet 37, a pickup roller 38, a fixing device 39, and a discharge stacking portion 40.

Now an image forming process in the color image forming apparatus of the present embodiment will be explained. The photosensitive drums 10a, 10b, 10c, 10d are rotated in a direction A, and, as a first step, are uniformly charged on the surfaces thereof with charging rollers 33. Then the optical scanning apparatus 31 causes laser beams to scan the photosensitive drums 10a, 10b, 10c, 10d. In this operation, the light emission points of the multi-beam laser light source 1 are turned on and off according to image information, thereby forming electrostatic latent images corresponding to the image information on the photosensitive drums 10a, 10b, 10c, 10d. Then, upon passing through the developing devices 32, toner are electrostatically deposited onto the photosensitive drums 10a, 10b, 10c, 10d. The toners are then transferred, by the primary transfer rollers 35, onto the intermediate transfer belt 34.

The intermediate transfer belt 34, being conveyed in a direction B, receives transfers of toners of different colors (typically yellow, magenta, cyan and black) from the photosensitive drums 10a, 10b, 10c, 10d in succession, thereby forming a full-color toner image.

On the other hand, the recording sheet 37 is fed by the pickup roller 38 in synchronization with the aforementioned toner image forming process and guided to the secondary transfer roller 36, thus receiving a transfer of the toner image from the intermediate transfer belt 34. Then the recording sheet 37 is subjected to a toner fixation by heat and pressure upon passing the fixing device, and is stacked on the discharge stacking portion 40, whereupon the image forming sequence is terminated.

(Feature of Optical Scanning Apparatus)

In the following there will be explained structures featuring the optical scanning apparatus of the present embodiment. A first feature is that the multi-beam laser light source 1 is constituted of a vertical cavity surface emitting laser (hereinafter represented as “VCSEL”) which is a planar light emission laser emitting a laser beam in a direction perpendicular to a device substrate.

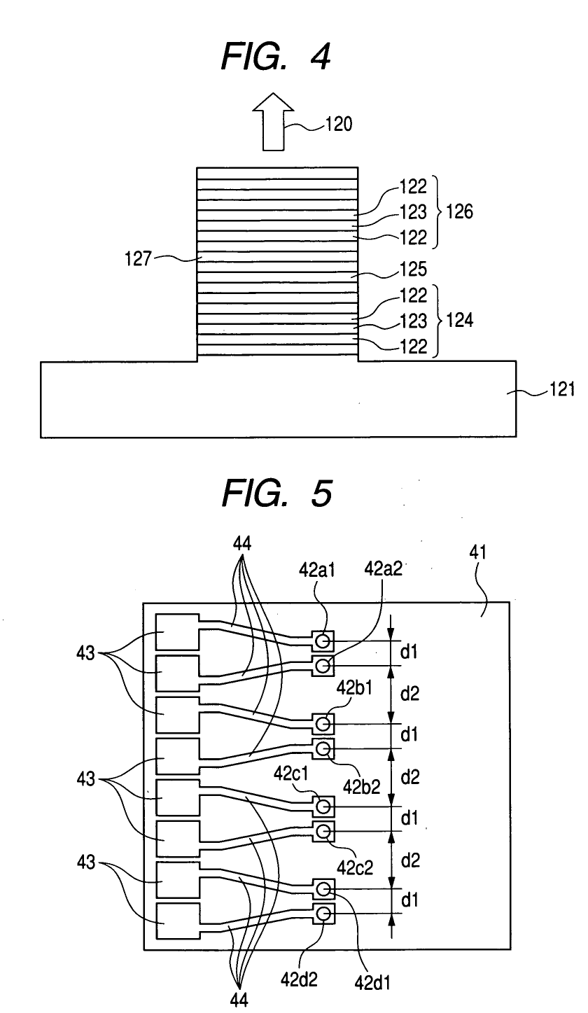

A VCSEL is constituted by forming in succession, on a semiconductor substrate 121 as shown in FIG. 4, a first multi-layered reflective film 124 prepared by alternately laminating a GaAs layer 122 and a GaAlAs layer 123, an active layer 125, and a second multi-layered reflective film 126 prepared by alternately laminating a GaAs layer 122 and a GaAlAs layer 123, and forming, between at least either of the first multi-layered reflective film 124 and the second multi-layered reflective film 126 (the second multi-layered reflective film 126 in the illustrated example) and the active layer 125, a current constricting layer 127 prepared by oxidizing a predetermined area of a junction plane of the AlAs layer farther from the active layer 125, and emits a laser beam in a direction indicated by an arrow 120.

Such VCSEL has a feature that a multi-beam structure is easier to attain in comparison with an end-face emission laser which emits a laser beam parallel to the device substrate and which is employed conventionally. This is firstly because the light emission points can be arranged two-dimensionally as the laser beam is emitted perpendicularly to the device substrate 121, and also because a thermal crosstalk can be made very small as the active layer of a small volume realizes a strong light enclosure thereby providing a very low oscillation threshold current and a low heat generation.

A crosstalk means a phenomenon that the light emission points positioned close mutually influence by the light emission thereby causing a fluctuation in the optical output, and a thermal crosstalk is representative of such phenomenon.

In general, an optical output of the semiconductor laser in a light emitting state under a constant current is strongly influenced by the temperature. Also the semiconductor laser generates heat at the light emitting operation. Thus, in case the light emission points are provided mutually close, the optical output of a light emission point fluctuates by on/off operation of the adjacent light emission point, and such phenomenon is called a thermal crosstalk.

For suppressing such thermal crosstalk, it is most effective to reduce the heat generation at the laser beam emission, namely to lower an oscillation threshold current. Therefore a VCSEL, characterized in a very low oscillation threshold current, can be considered ideal for a system requiring 8 or more multiple beams.

A second feature lies in the arrangement of the light emission points. As will be apparent from FIG. 1, a separation of 8 laser beams emitted from a single multi-beam laser light source 1 into pairs in four directions is difficult in case the laser beams have a uniform gap (uniform angle between the laser beams). It is desirable, as shown in FIG. 1, that the beams directed to a same photosensitive drum have a smaller gap and those directed to different photosensitive drums have a larger gap. In case the beams have a uniform gap (for example the angle between the laser beams La1 and La2 being increased same as the angle between the laser beams La2 and Lb1), the fold-back mirror 9 has to be given a larger width, whereby a fold-back mirror 9 positioned in front shields the laser beams directed to a fold-back mirror positioned in the back. In the present embodiment, therefore, a distance between the first light emission point group emitting the first laser beam group and the second light emission point group emitting the second laser beam group is larger than a distance between the light emission points of the first light emission point group.

FIG. 5 is a schematic view of a VCSEL employed in the present embodiment as the multi-beam laser light source 1, seen from a laser beam emitting direction.

In FIG. 5, there are shown a device substrate 41 (substrate of semiconductor laser chip), and light emission points 42a1, 42a2, 42b1, 42b2, 42c1, 42c2, 42d1 and 42d2 which, formed on the device substrate, are provided in 8 units in the present embodiment and which emit independently modulatable laser beams in a direction perpendicular to the device substrate 41 (perpendicular to the plane of drawing). Among these, 42a1 and 42a2 constitute a first light emission point group, 42b1 and 42b2 constitute a second light emission point group, 42c1 and 42c2 constitute a third light emission point group, and 42d1 and 42d2 constitute a fourth light emission point group.

Electrode pads 43 are electrically connected with the light emission points 42a1, 42a2, 42b1, 42b2, 42c1, 42c2, 42d1 and 42d2 through electrodes 44. The electrode pads 43 are also connected with unillustrated metal wires for connection with a circuit board for driving the VCSEL.

The laser beams emitted from the light emission points 42a1, 42a2 reach the photosensitive drum 10a, while the laser beams emitted from the light emission points 42b1, 42b2 reach the photosensitive drum 10b. Similarly, the laser beams emitted from the light emission points 42c1, 42c2 reach the photosensitive drum 10c, while the laser beams emitted from the light emission points 42d1, 42d2 reach the photosensitive drum 10d.

Therefore, a gap d1 between the light emission points 42a1 and 42a2 is made narrower, while a gap d2 between the light emission points 42a2 and 42b1 is made wider. Similarly, a gap between the light emission points 42b1 and 42b2, 42c1 and 42c2, or 53d1 and 42d2 is made narrower, while a gap between the light emission points 42b2 and 42c1 or 42c2 and 42d1 is made wider (d1<d2). In this manner the separation is facilitated between the laser beams leading to the different photosensitive drums.

As explained in the foregoing, the present embodiment allows to provide an optical scanning apparatus capable of achieving a high recording speed, suppressing an image quality deterioration by a crosstalk and avoiding an interception of a laser beam directed to a photosensitive drum on the way, thereby easily realizing a color image forming apparatus of a high image quality.

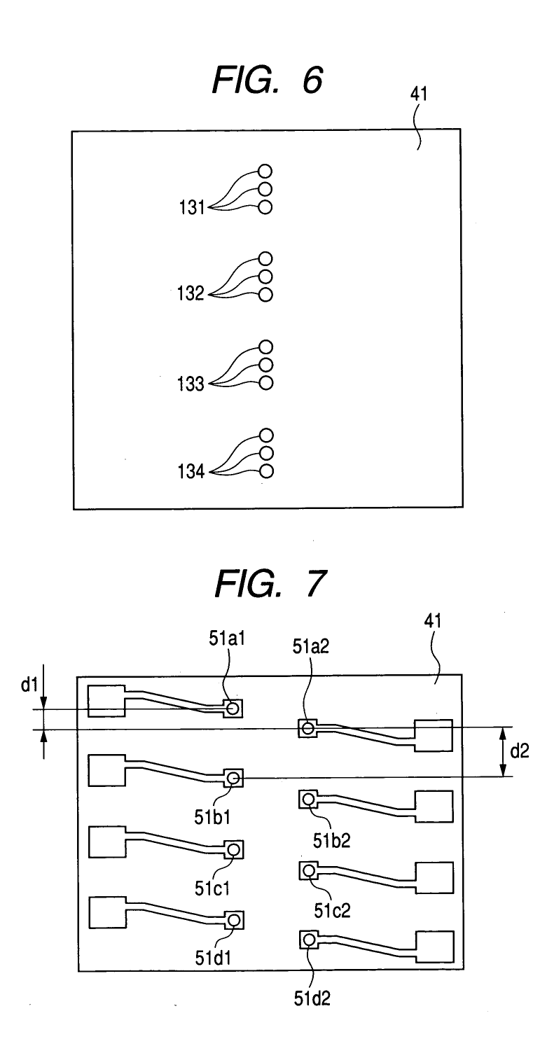

The present embodiment scans each photosensitive drum with two beams, but, in case of employing a larger number of beams, the light emission points may be arranged as shown in FIG. 6. FIG. 6 shows an example with a first light emission point group 131, a second light emission point group 132, a third light emission point group 133, and a fourth light emission point group 134, in which each light emission point group provides 3 beams. In this manner a tripled recording speed can be attained.

### Second Embodiment

In the following, an apparatus of a second embodiment will be explained with reference to FIGS. 7 to 11. A basic configuration of the apparatus of the present embodiment, being same as that in the foregoing embodiment, will not therefore be explained in repetition and there will be explained only configurations featuring the present embodiment. Also components same in function as those in the foregoing embodiment will be represented by same numbers.

FIG. 7 shows a multi-beam laser light source employed in the second embodiment of the present invention. A multi-beam laser light source of VCSEL type is employed also in the present embodiment.

In FIG. 7, there are shown light emission points 51a1, 51a2, 51b1, 51b2, 51c1, 51c2, 51d1 and 51d2, among which the light emission points 51a1 and 51a2 constitute a first light emission point group, 51b1 and 51b2 constitute a second light emission point group, 51c1 and 51c2 constitute a third light emission point group, and 51d1 and 51d2 constitute a fourth light emission point group.

Also in the present embodiment, as in the first embodiment, the light emission points emitting laser beams leading to a same photosensitive drum, such as the light emission points SIal and 51a2, have a narrower gap d1, while the light emission points emitting laser beams leading to different photosensitive drums, such as the light emission points 51a2 and 51b1, have a wider gap d2 (d1<d2). In the present embodiment, in addition, the light emission points emitting laser beams leading to a same photosensitive drum (for example light emission points 51a1 and 51a2) are spaced m a main scanning direction (lateral direction in the illustration) which is an optical scanning direction of the photosensitive drum by the optical scanning apparatus. More specifically, in the first light emission point group, a first light emission point 51a1 and a second light emission point 51a2 are separated in the main scanning direction, and also in the second light emission point group, a first light emission point 51b1 and a second light emission point 51b2 are separated in the main scanning direction.

More specifically, the light emission points 51a1, 51b1, 51c1 and 51d1 are arranged on a straight line in a sub scanning direction (vertical direction in the illustration), and the light emission points 51a2, 51b2, 51c2 and 51d2 are arranged on a straight line in a sub scanning direction.

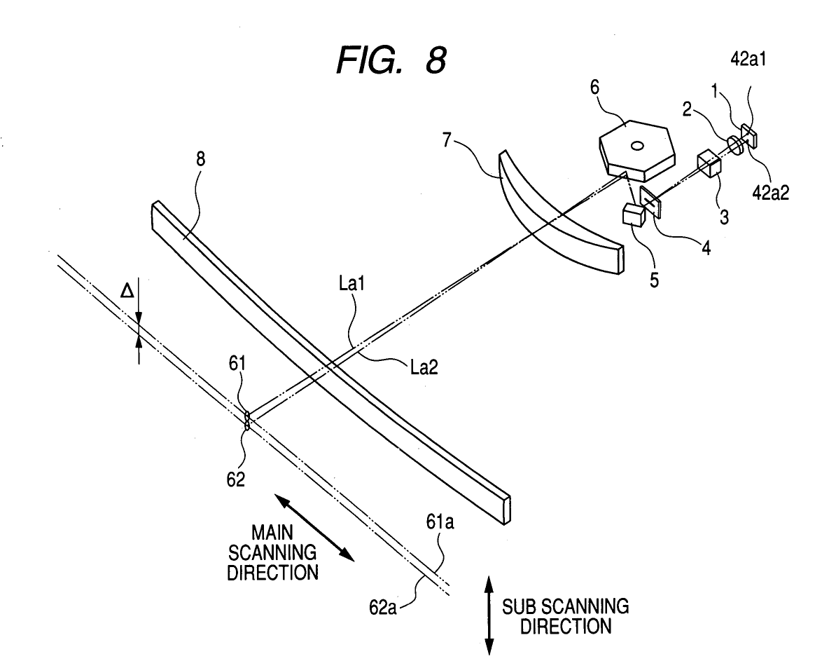

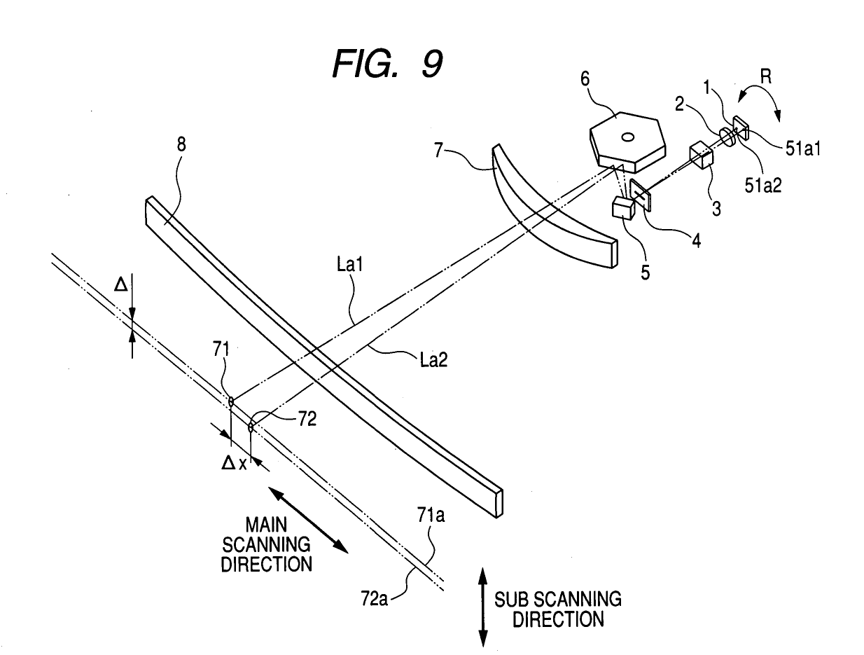

Such arrangement is to enable a gap regulation of scanning lines formed by laser spots focused on the drum surface, as will be explained with reference to FIGS. 8 to 10A and 10B. In FIGS. 8 and 9, only one photosensitive drum 10a is considered, for the purpose of simplicity, as a representative of plural photosensitive drums, and the fold-back mirror 9 or the like is omitted.

FIG. 8 shows a case where the light emission points are arranged along a line as in the first embodiment. In this case, the laser beams La1, La2 emitted from the light emission points 42a1, 42a2 are respectively focused as laser spots 61, 62 on the photosensitive drum 10a, and form scanning lines 61a, 61b by the rotation of the polygon mirror 6. In such arrangement, the laser spots 61, 62 are in a same position in the main scanning direction, like the light emission points 42a1, 42a2. Therefore the two spots 61, 62 enter the synchronization sensor 13 (FIG. 2) at a same timing, and the semiconductor laser chip of the first embodiment is suitable for an apparatus which controls the light emission timing of the two light emission points 42a1, 42a2 by a single synchronization signal obtained by a timing of simultaneous entry of the two spots 61, 62 into the synchronization sensor 13. Stated differently, it is difficult to distinguish the spots 61 and 62 even in case they have somewhat different timings of entry into the synchronization sensor 13.

On the other hand, a spacing A of the scanning lines 61a, 62a is uniquely determined by the resolution of the image forming apparatus, and is set for example at 42.3 μm in case of a resolution of 600 dpi (dot/inch). Such spacing, unless set strictly, results in a periodical aberration in the dot position, leading to a deterioration of the image quality such as a moiré pattern by an interference with an image pattern. Such setting is usually executed by suitably selecting a magnification of the optical system based on the gap of the light emission points and the resolution, but a certain error is unavoidable in practice, by an error in the manufacture and in the oscillation wavelength of the laser beams. However, in case the semiconductor laser chip is rotated about an optical axis thereof in order to regulate the spacing. A between the two scanning lines 61a, 62a, the two spots 61, 62 show aberration in the positions thereof in the main scanning direction. In the optical scanning apparatus of the embodiment 1, as it is difficult, as explained above, to distinguish the spots 61 and 62 even when they have somewhat different timings of entry into the synchronization sensor 13, it is difficult to correct the aberration of the spots 61, 62 in the main scanning direction caused by a rotational regulation of the semiconductor laser chip, by a regulation of light emission timings of the two light emission points 42a1, 42a2. Therefore, in case of employing the semiconductor laser chip of the embodiment 1, it is practically difficult to execute a rotational regulation of the semiconductor laser chip, namely to regulate a spacing A of the two scanning lines 61a, 62a.

In consideration of the foregoing, the present embodiment enables a space regulation of the scanning lines by rotating the multi-beam laser light source about its optical axis, as will be explained in the following with reference to FIG. 9.

In the configuration shown in FIG. 9, as light emission points 51a1, 51a2 are spaced also in the main scanning direction, laser beams La1, La2 are focused on the photosensitive drum 10a as laser spots 71, 72 which are separated not only by a spacing Δ in the sub scanning direction but also by a spacing Δx in the sub scanning direction. In this state, the spacing Δ of the scanning lines in the sub scanning direction can be regulated by rotating the multi-beam laser light source 1 about an optical axis (in a direction indicated by an arrow R).

In case of employing the semiconductor laser chip of the embodiment 2, the laser spots 71, 72 are spaced in the main scanning direction, so that the two spots 61, 62 have different timings of entry into the synchronization sensor 13 (FIG. 2), corresponding to the distance Δx. Such distance Δx is sufficient for distinguishing the two spots 61, 62 entering the synchronization sensor 13 and a change in the distance Δx caused by a rotational regulation of the semiconductor laser chip can be corrected by the light emission timings of the two light emission points 51a1, 51a2.

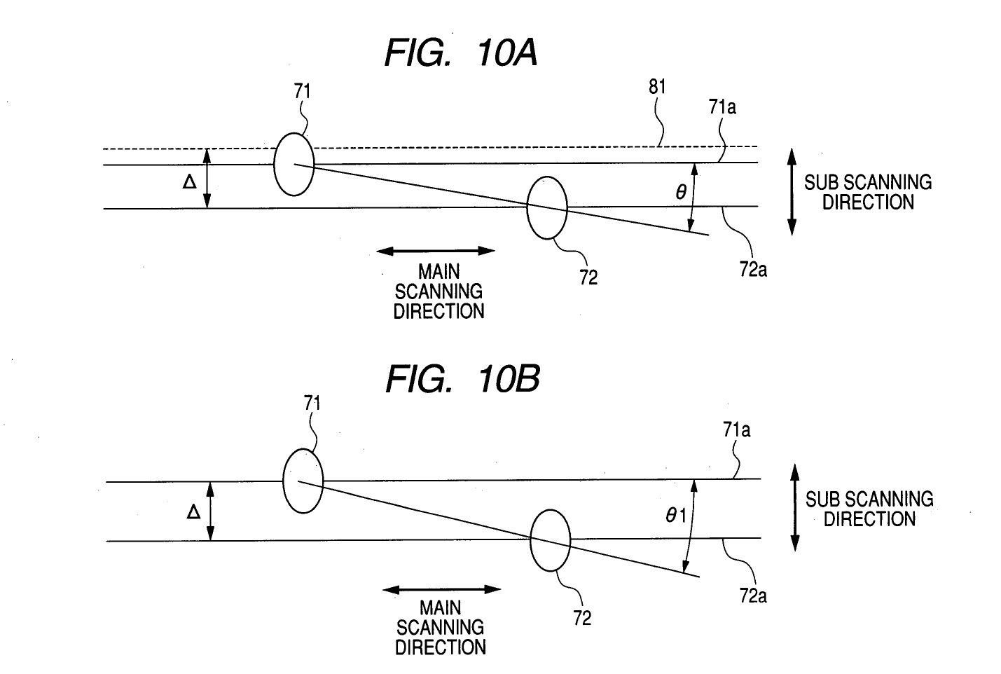

A mode of regulation of the distance Δ will be explained with reference to FIGS. 10A and 10B, showing laser spots and scanning lines on the photosensitive drum. In FIGS. 10A and 10B, there are shown laser spots 71a, 72a and scanning lines 71, 72 formed by a scanning caused by the rotation of the polygon mirror 6.

FIG. 10A shows a case where a spacing of the scanning lines 71a, 72a is smaller than a design value A (81 indicating an ideal position of the scanning line) In such case, the multi-beam laser light source 1 is rotated about the optical axis in such a manner that an angle θ formed by a line of the laser spots 71, 72 and the main scanning direction becomes larger. FIG. 10B shows a state after such regulation.

As explained in the foregoing, the present embodiment employs a configuration in which a distance d2 between the first light emission point group emitting the first laser beam group in the semiconductor laser chip, and the second light emission point group emitting the second laser beam group in the semiconductor laser chip, is larger than a distance d1 between the light emission points in the first light emission point group, and in which a first light emission point and a second light emission point in the first light emission point group are spaced in the main scanning direction and a first light emission point and a second light emission point in the second light emission point group are also spaced in the main scanning direction, thereby facilitating the separation of the laser beams directed to the different photosensitive drums and also enabling a regulation of the spacing of the scanning lines.

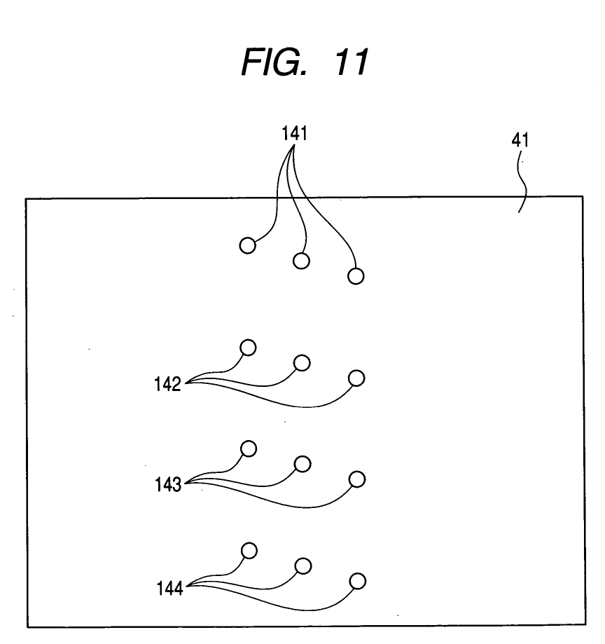

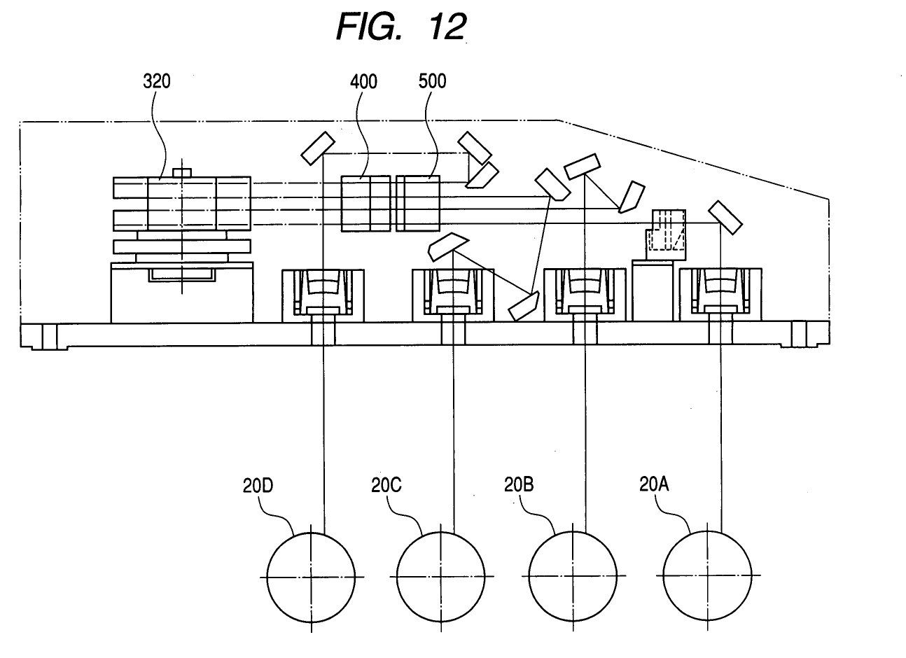

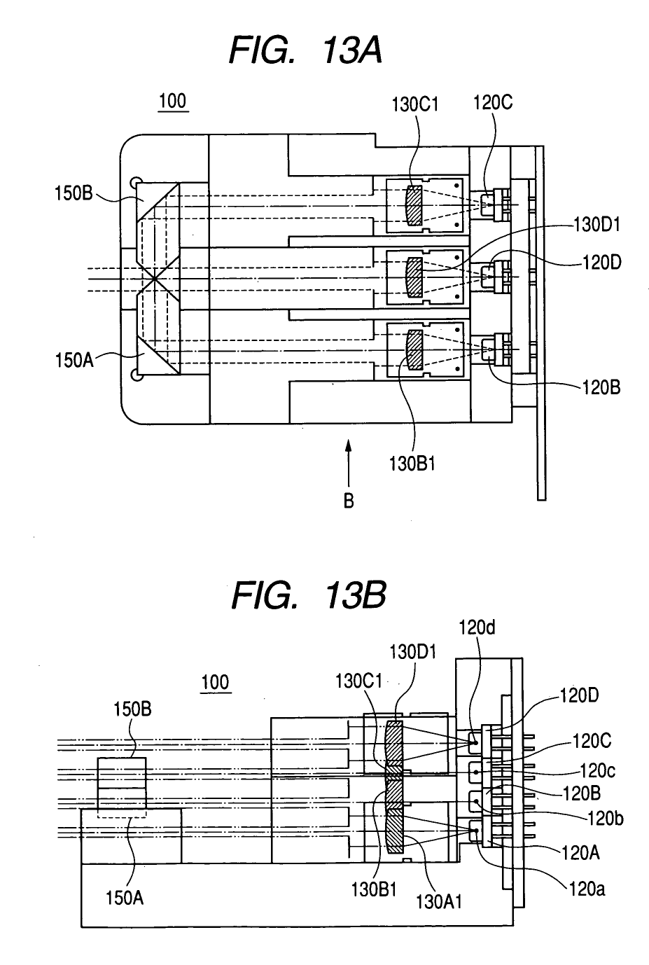

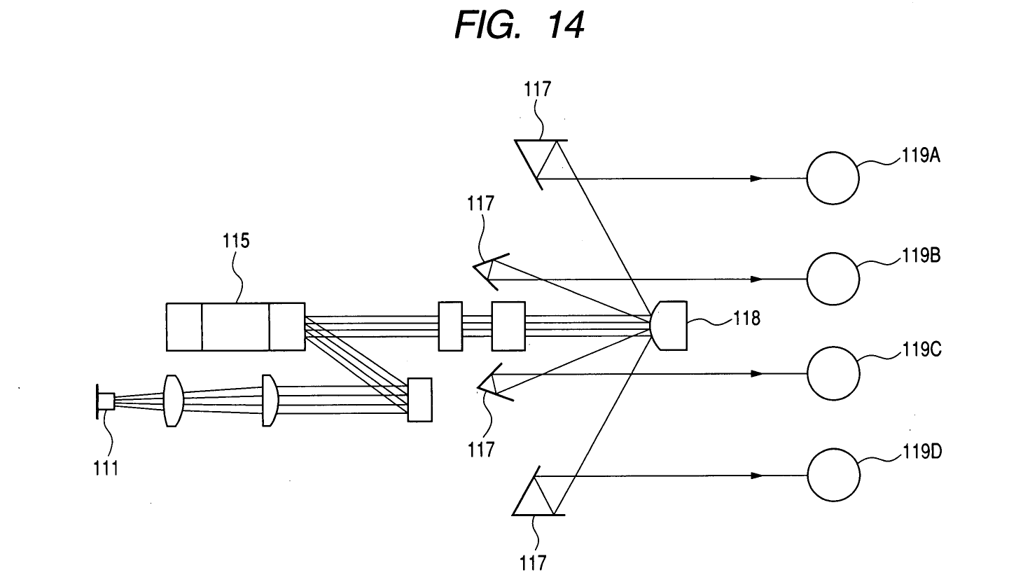

In the present embodiment, each photosensitive drum is scanned with two beams, but, in case of employing a larger number of beams, the light emission points may be positioned as shown in FIG. 11, which shows a first light emission point group 141, a second light emission point group 142, a third light emission point group 143, and a fourth light emission point group 144, each constituted of 3 beams.

The present invention is not limited to the foregoing embodiments but is subject to any and all modifications within the technical concept of the present invention.

This application claims priority from Japanese Patent Application No. 2004-047397 filed Feb. 24, 2004, which is hereby incorporated by reference herein.

1. An optical scanning apparatus for mounting in an image forming apparatus having plural photosensitive members, comprising:
a semiconductor laser chip having plural light emission points; and
deflection means which deflects plural laser beams emitted from said semiconductor laser chip;
wherein said semiconductor laser chip is a vertical cavity surface emitting laser for emitting a laser beam in a direction perpendicular to a substrate plane of the chip, and, a first laser beam group constituted at least of two laser beams, among plural laser beams deflected by said deflection means, enters a first photosensitive member while a second laser beam group constituted at least of two laser beams other than the first laser beam group, among plural laser beams deflected by said deflection means, enters a second photosensitive member; and
wherein a distance d2 between a first light emission point group emitting the first laser beam group on said semiconductor laser chip and a second light emission point group emitting the second laser beam group on said semiconductor laser chip is larger than a distance d1 of light emission points of the first light emission point group.

2. An optical scanning apparatus according to claim 1, wherein said plural light emission points are arranged along a straight line.

3. An optical scanning apparatus according to claim 1, wherein a first light emission point and a second light emission point of the first light emission point group are spaced in a main scanning direction, and also a first light emission point and a second light emission point of the second light emission point group are spaced in a main scanning direction.

4. An optical scanning apparatus according to claim 3, wherein a first light emission point of the first light emission point group and a first light emission point of the second light emission point group are arranged along a sub scanning direction, and also a second light emission point of the first light emission point group and a second light emission point of the second light emission point group are arranged along a sub scanning direction.

5. A semiconductor laser chip for mounting in an optical scanning apparatus comprising:
a substrate; and
plural light emission points formed on said substrate for emitting laser beams in a direction perpendicular to a plane of the substrate;
wherein a distance d2 between a first light emission point group emitting a first laser beam group constituted at least of two laser beams, among plural laser beams emitted from said plural light emission points, and a second light emission point group emitting a second laser beam group constituted at least of two laser beams other than the first laser beam group, is larger than a distance d1 of light emission points of the first light emission point group.

6. A semiconductor laser chip according to claim 5, wherein said plural light emission points are arranged along a straight line.

7. A semiconductor laser chip according to claim 5, wherein a first light emission point and a second light emission point of the first light emission point group are spaced in a main scanning direction, and also a first light emission point and a second light emission point of the second light emission point group are spaced in a main scanning direction.

8. A semiconductor laser chip according to claim 7, wherein a first light emission point of the first light emission point group and a first light emission point of the second light emission point group are arranged along a sub scanning direction, and also a second light emission point of the first light emission point group and a second light emission point of the second light emission point group are arranged along a sub scanning direction.
